(19) United States
(12) Patent Application Publication
(10) Pub. No.: US 2013/0170655 A1
(43) Pub. Date: Jul. 4, 2013

(54) AUDIO OUTPUT DEVICE AND AUDIO OUTPUT METHOD

(71) Applicants: Kazuhiro Satoyoshi, Hamamatsu-shi (JP); Kosuke Saito, Hamamatsu-shi (JP)

(72) Inventors: Kazuhiro Satoyoshi, Hamamatsu-shi (JP); Kosuke Saito, Hamamatsu-shi (JP)

(73) Assignee: YAMAHA CORPORATION, Hamamatsu-shi, Shizuoka (JP)

(21) Appl. No.: 13/822,045

(22) PCT Filed: Sep. 27, 2011
(86) PCT No.: PCT/JP2011/072130

§ 371 Date: Mar. 11, 2013

(30) Foreign Application Priority Data
Sep. 28, 2010 (JP) 2010-216270
Mar. 23, 2011 (JP) 2011-063438

(51) Int. Cl. G10K 11/00

(52) U.S. Cl. CPC G10K 11/002
USPC 381/56; 381/59

(57) ABSTRACT

A audio output device includes: a speaker position detecting unit which detects the position of a speaker; a masking sound producing section which produces a masking sound; a plurality of loudspeakers which output the masking sound; and a localization controlling section which controls a localization position of the masking sound based on the speaker position detected by the speaker position detecting unit, and which supplies a sound signal relating to the masking sound to at least one of the plurality of loudspeakers.

### TECHNICAL FIELD

The present invention relates to an audio output device which outputs a masking sound, and also to an audio output method.

### BACKGROUND ART

Conventionally, a technique has been proposed in which, in an office or the like, a loudspeaker is attached to a partition, a sound having a low relevance to the voice of the speaker is output as a masking sound to cause the voice of the speaker to be hardly heard by persons existing in the space where the speaker exists, and adjacent other spaces (for example, see Patent Document 1). According to the configuration, the uttered content of the speaker is hardly understood, and therefore the privacy of the speaker can be maintained.

### PRIOR ART REFERENCE

### Patent Document

Patent Document 1: JP-A-6-175666

### SUMMARY OF THE INVENTION

### Problems to be Solved by the Invention

In the system of Patent Document 1, however, the masking sound and the voice of the speaker are heard from different positions. Consequently, there is a possibility that, because of the so-called cocktail party effect, the listener may distinguish the voice of the speaker and understand the uttered content.

Therefore, it is an object of the invention to provide an audio output device and audio output method in which the cocktail party effect can be adequately suppressed.

### Means for Solving the Problem

The audio output device which can solve the problem includes: a speaker position detecting section adapted to detect a position of a speaker; a masking sound producing section adapted to produce a masking sound; a plurality of loudspeakers adapted to output the masking sound; and a localization controlling section adapted to control a localization position of the masking sound based on the speaker position detected by the speaker position detecting section, and supply a sound signal relating to the masking sound to at least one of the plurality of loudspeakers.

Preferably, the localization controlling section sets the localization position of the masking sound to the speaker position detected by the speaker position detecting section.

Preferably, the audio output device includes a microphone array in which a plurality of microphones that pick up a sound are arranged, and the speaker position detecting section detects the speaker position based on a phase difference of sounds picked up by the plurality of microphones.

Preferably, the masking sound producing section sets a level of the masking sound to a high level in a case where the speaker position detected by the speaker position detecting section is changed.

Preferably, the speaker position detecting section sets a position of a microphone in which a volume level of a picked-up sound is highest, as the speaker position, and the localization controlling section supplies the sound signal relating to the masking sound, to a loudspeaker that is closest to the microphone in which the volume level of the picked-up sound is highest.

The audio output device which can solve the problem includes: a plurality of microphones adapted to pick up a sound; a masking sound producing section adapted to produce a masking sound; a plurality of loudspeakers to which a sound signal relating to the masking sound is supplied, and adapted to emit the masking sound; and a localization controlling section adapted to control a gain of the sound signal relating to the masking sound to be supplied to the plurality of loudspeakers, and the localization controlling section multiplies levels of picked-up sound signals of the plurality of microphones with a gain setting coefficient having a value which becomes smaller as distances between the plurality of microphones and the plurality of loudspeakers are larger, to adjust the gain of the sound signal relating to the masking sound to be supplied to the plurality of loudspeakers.

The audio output method which can solve the problem includes the steps of: detecting a position of a speaker; producing a masking sound; outputting the masking sound from at least one of a plurality of loudspeakers; and controlling a localization position of a virtual sound source of the masking sound so that a position of the virtual sound source is placed at or in a vicinity of the speaker position detected in the speaker position detecting step, and supplying a sound signal relating to the masking sound to at least one of the plurality of loudspeakers.

Preferably, in the localization controlling step, the localization position of the masking sound is set to the speaker position detected in the speaker position detecting step.

Preferably, the audio output method further includes a step of picking up a sound by a microphone array in which a plurality of microphones are arranged, and, in the speaker position detecting step, the speaker position is detected from a phase difference of sounds picked up by the plurality of microphones.

Preferably, in a case where the speaker position detected in the speaker position detecting step is changed, the masking sound producing step sets a level of the masking sound to a high level.

Preferably, in the speaker position detecting step, a position of a microphone in which a volume level of a picked-up sound is highest is set as the speaker position, and, in the localization controlling step, the sound signal relating to the masking sound is supplied to a loudspeaker that is closest to the microphone in which the volume level of the picked-up sound is highest.

The audio output method which can solve the problem includes the steps of: picking up a sound by a plurality of microphones; producing a masking sound; supplying a sound signal relating to the masking sound to a plurality of loudspeakers, and emitting the masking sound by the plurality of loudspeakers; and controlling a gain of the sound signal relating to the masking sound which is to be supplied to the plurality of loudspeakers, and the localization controlling step multiplies levels of picked-up sound signals of the plurality of microphones with a gain setting coefficient having a value which becomes smaller as a distance between the plurality of microphones and the plurality of loudspeakers is larger, to adjust the gain of the sound signal relating to the masking sound to be supplied to the plurality of loudspeakers.

### Advantageous Effects of the Invention

According to the invention, the masking sound and the voice of the speaker are heard in the same direction, and therefore the cocktail party effect can be adequately suppressed.

### BRIEF DESCRIPTION OF THE DRAWINGS

FIG. 1 is a block diagram showing the configuration of a masking system.

FIG. 2 is a block diagram showing the configurations of a microphone array, a loudspeaker array, and a sound processing device.

FIG. 3 is a view showing a method of detecting a speaker position by using the microphone array.

FIG. 4 is a view showing a method of localizing a virtual sound source by using the loudspeaker array.

FIG. 5 is a view showing positional relationships between the loudspeaker array and the microphone array.

FIG. 6 is a flowchart showing the operation of the sound processing device.

FIG. 7 is a view showing the configuration of a masking system in another embodiment.

FIG. 8 is a block diagram showing the configurations of a microphone array, loudspeaker array, and sound processing device of the masking system shown in FIG. 7.

FIG. 9 is a flowchart showing the operation of the sound processing device in the masking system shown in FIG. 7.

FIG. 10 is a view showing the configuration of a masking system in a further embodiment.

FIG. 11 is a block diagram showing the configurations of a microphone array, loudspeaker array, and sound processing device of the masking system shown in FIG. 10.

### MODE FOR CARRYING OUT THE INVENTION

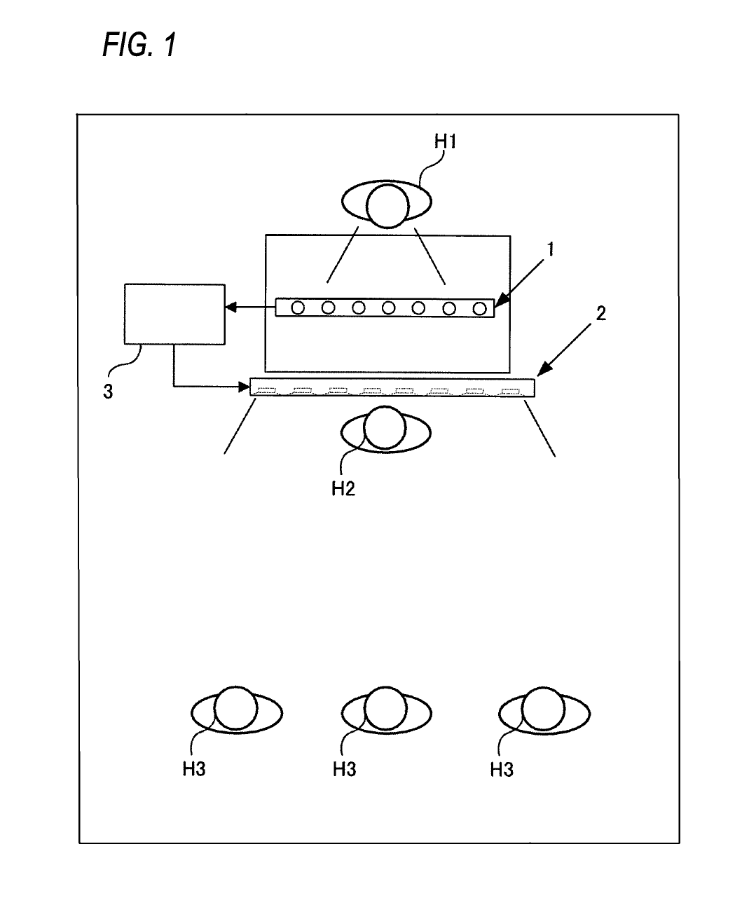

FIG. 1 is a block diagram showing the configuration of a masking system including the audio output device of the invention. For example, the masking system is disposed on an interactive counter in a bank, a dispensing pharmacy, or the like, and emits to a third person a masking sound which causes the content of a conversation between persons conversating with each other across the counter, not to be understood by the third person.

In FIG. 1, a speaker H1 and a listener H2 exist across the counter, and a plurality of third persons H3 exist at positions remote from the counter. Since H1 and H2 conversate with each other, occasionally, H1 is a listener, and H2 is a speaker. For example, the speaker H1 is a pharmacist who explains about a drug, the listener H2 is a patient who hears the explanation of the drug, and the third persons H3 are waiting patients.

A microphone array 1 is disposed on the upper surface of the counter. In the microphone array 1, a plurality of microphones are arranged, and each of the microphones picks up a sound in the periphery of the counter. In the direction of the counter in which the third persons exist (the downward direction in the sheet), a loudspeaker array 2 which outputs a sound toward the third persons is disposed. The loudspeaker array 2 is disposed, for example, under a desk so that the listener H2 hardly hears the sound output from the loudspeaker array 2.

The microphone array 1 and the loudspeaker array 2 are connected to a sound processing device 3. The microphone array 1 picks up the voice of the speaker H1 through the arranged microphones, and outputs the picked up voice to the sound processing device 3. The sound processing device 3 detects the position of the speaker H1 based on the voice of the speaker H1 which is picked up by the microphones of the microphone array 1. Moreover, the sound processing device 3 produces a masking sound for masking the voice of the speaker H1 based on the voice of the speaker H1 which is picked up by the microphones of the microphone array 1, and outputs the masking sound to the loudspeaker array 2. At this time, the sound processing device 3 controls delay amounts of sound signals to be supplied to the loudspeakers of the loudspeaker array 2, whereby the position (position of the virtual sound source) of a sound source which is sensed by the third persons H3 is set to the position of the speaker H1. This causes the third persons H3 to hear the voice of the speaker H1 and the masking sound from the same position, and the cocktail party effect is adequately suppressed.

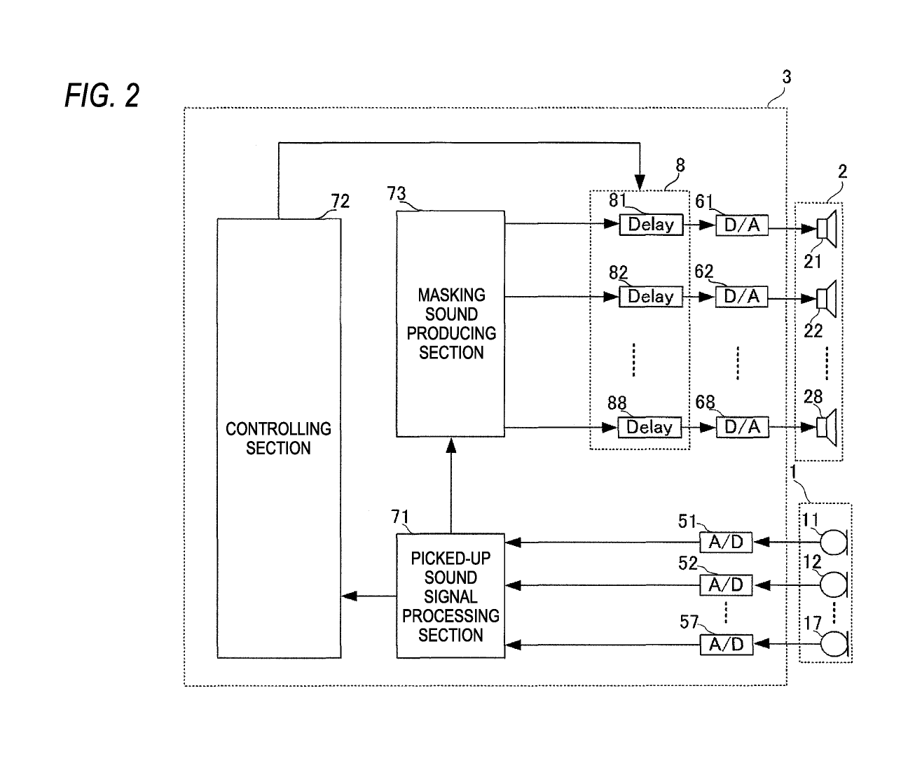

Hereinafter, the specific configuration and operation for realizing the above-described masking system will be described. FIG. 2 is a block diagram showing the configurations of the microphone array 1, the loudspeaker array 2, and the sound processing device 3. The microphone array 1 includes seven microphones 11 to 17. The sound processing device 3 includes A/D converters 51 to 57, a picked-up sound signal processing section 71, a controlling section 72, a masking sound producing section 73, a delay processing section 8, and D/A converters 61 to 68. The loudspeaker array 2 includes eight loudspeakers 21 to 28. The number of the microphones of the microphone array, and that of the loudspeakers of the loudspeaker array are not limited to this example.

The A/D converters 51 to 57 receive voices picked up by the microphones 11 to 17, and convert the voices to digital sound signals, respectively. The digital sound signals which are converted by the ND converters 51 to 57 are supplied to the picked-up sound signal processing section 71.

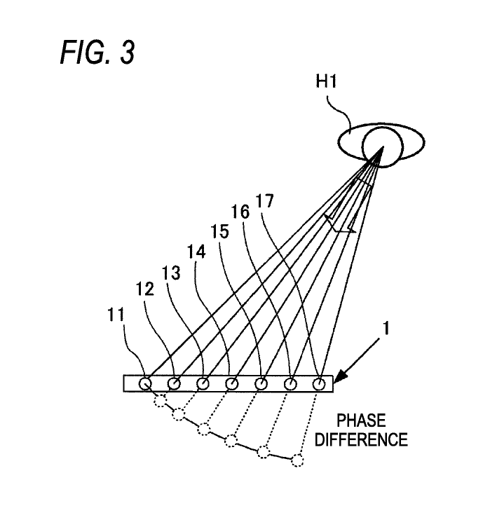

The picked-up sound signal processing section 71 detects the phase differences between the digital sound signals to detect the position of the speaker. FIG. 3 is a view showing an example of the method of detecting the speaker position. As shown in the figure, when the speaker H1 utters a voice sound, the sound first reaches the microphone (in the figure, the microphone 17) which is closest to the speaker H1, and thereafter reaches the other microphones in the sequence of the microphone 16 to the microphone 11 as time elapses. The picked-up sound signal processing section 71 obtains correlations between the sounds picked up by the microphones, and acquires the differences (phase differences) between timings when the sound arrives from the same sound source. The picked-up sound signal processing section 71 assumes that the microphones exist at virtual positions (in the figure, the positions of the circles each indicated by the broken line) where the phase differences are considered, and detects the speaker position under assumption that the sound source (speaker H1) exists at a position where the distances from the virtual positions of the microphones are equal to one another. The information of the detected sound source position is output to the controlling section 72. For example, the information of the sound source position is information indicating the distance and direction (deviation angle in the case where the front direction is set to 0 deg.) with respect to the center position of the microphone array 1.

Moreover, the picked-up sound signal processing section 71 outputs the digital sound signals relating to the speaker voice picked up from the detected speaker position, to the masking sound producing section 73. The picked-up sound signal processing section 71 may have a configuration where a sound picked up by one microphone of the microphone array 1 is output, or may have another configuration where the digital sound signals picked up by the microphones are synthesized after being delayed based on the above phase differences to equalize the phases, thereby realizing characteristics having a high sensitivity (directionality) in the position of the sound source, and the synthesized digital sound signal is output. According to the configuration, the speaker voice is mainly picked up with a high SN ratio, and unwanted noises and a feedback sound of the masking sound output from the loudspeaker array are caused to be hardly picked up by the microphone array 1.

Next, based on the speaker voice supplied from the picked-up sound signal processing section 71, the masking sound producing section 73 produces a masking sound for masking the speaker voice. The masking sound may be any kind of sound, but preferably may be a sound which brings a less uncomfortable feeling of the listener. For example, a sound may be used which is produced by holding the uttered voice of the speaker H1 for a predetermined time period, and modifying the voice on the time axis or the frequency axis to be converted to a sound having no lexical meaning (the content of conversation cannot be understood). Alternatively, general-purpose uttered voices which are voices of a plurality of men and women, and which have no lexical meaning may be previously stored in an internal storage section (not shown), and a sound in which the frequency characteristics of the general-purpose voices, such as the formant are approximated to the voice of the speaker H1 may be used. Moreover, environmental sounds (such as a murmur of a brook) and dramatic sounds (such as a bird song) may be added to the masking sound. The produced masking sound is supplied to delay devices 81 to 88 of the delay processing section 8.

The delay devices 81 to 88 of the delay processing section 8 are disposed correspondingly to loudspeakers 21 to 28 of the loudspeaker array 2, respectively, and independently change the delay amounts of the sound signals to be supplied to the loudspeakers. The delay amounts in the delay devices 81 to 88 are controlled by the controlling section 72.

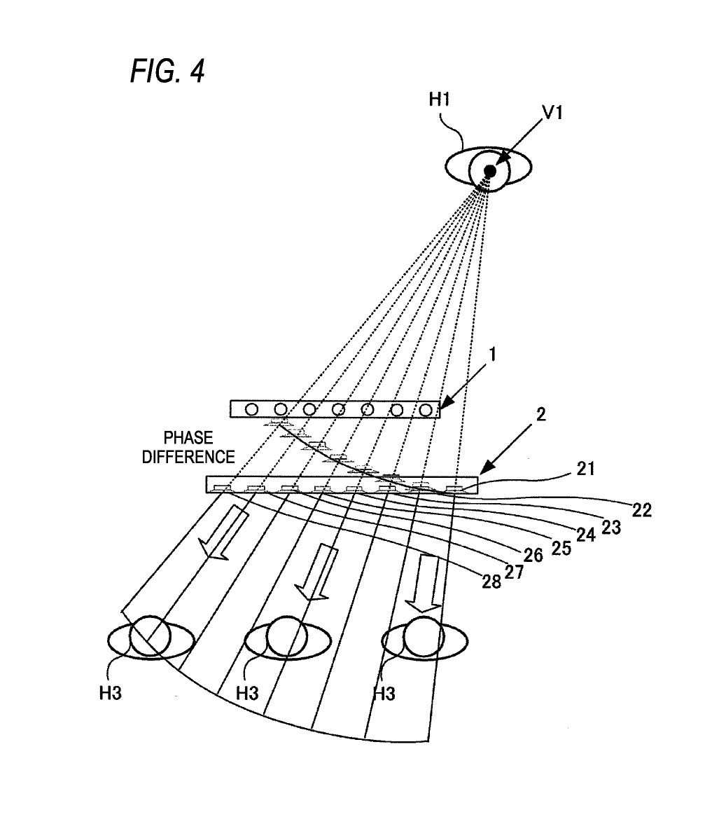

The controlling section 72 can set the virtual sound source to a predetermined position, by controlling the delay amounts in the delay devices 81 to 88. FIG. 4 is a view showing a method of localizing the virtual sound source by using the loudspeaker array.

As shown in the figure, the controlling section 72 sets the virtual sound source V1 to the position of the speaker H1 which is supplied from the picked-up sound signal processing section 71. The distances from the virtual sound source V1 to the loudspeakers of the loudspeaker array 2 are different from one another. When a sound is output from the loudspeakers in the sequence beginning with the loudspeaker (in the figure, the loudspeaker 21) which is closest to the virtual sound source V1, and as time elapses from the loudspeaker 22 to the loudspeaker 28, it is possible to cause the third persons (listeners) H3 to sense that the loudspeakers exist at positions (in the figure, the positions of the loudspeakers each indicated by the broken line) where the distances from the position of the virtual sound source functioning as a focal point are equal to one another, and the masking sound is emitted simultaneously from these virtual loudspeaker positions. Therefore, the third persons H3 sense that the masking sound is virtually emitted from the position of the speaker H1. It is not required that the position of the speaker H1 completely coincides with that of the virtual sound source V1 as shown in the figure. For example, only the arrival directions of the sounds may be made coincident with one another.

The controlling section 72 may set the delay amounts of the sound signals to be supplied to the loudspeakers under assumption that the microphone array 1 and the loudspeaker array 2 are disposed at the same position. However, it is more preferable to set the delay amounts based on the positional relationship between the microphone array 1 and the loudspeaker array 2. In the case where the microphone array 1 and the loudspeaker array 2 are disposed in parallel, for example, the controlling section 72 receives the center-to-center distance between the microphone array 1 and the loudspeaker array 2, corrects positional deviations of the loudspeakers of the loudspeaker array, and then calculates the delay amounts.

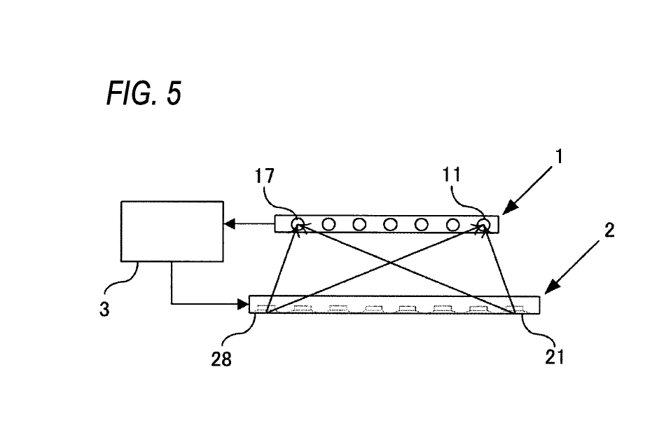

With respect to the positional relationship between the microphone array 1 and the loudspeaker array 2, a configuration may be employed where an operating section (not shown) which is operated by the user is disposed, and a manual input by the user is received. Alternatively, for example, the positional relationship between the microphone array 1 and the loudspeaker array 2 may be detected by outputting sounds from the loudspeakers of the loudspeaker array 2, and picking up the sounds by the microphones of the microphone array 1 to measure the arrival times. In this case, a configuration is employed where, such as shown in FIG. 5, a measurement sound (such as an impulse sound) is output from the end loudspeakers 21 and 28 of the loudspeaker array 2, and the timings when the measurement sound is picked up by the end microphones 11 and 17 of the microphone array 1 are measured. In this case, the distances between the end portions of the microphone array 1 and the loudspeaker array 2 can be measured, and the disposition angles of the microphone array 1 and the loudspeaker array 2 can be detected.

In a casing in which the loudspeaker array 2 and the microphone array 1 are integrated with each other, the positional relationship between the loudspeaker array 2 and the microphone array 1 is fixed, and, when the positional relationship is previously stored, it is not necessary to input or measure the positional relationship each time when the sound processing device 3 is activated.

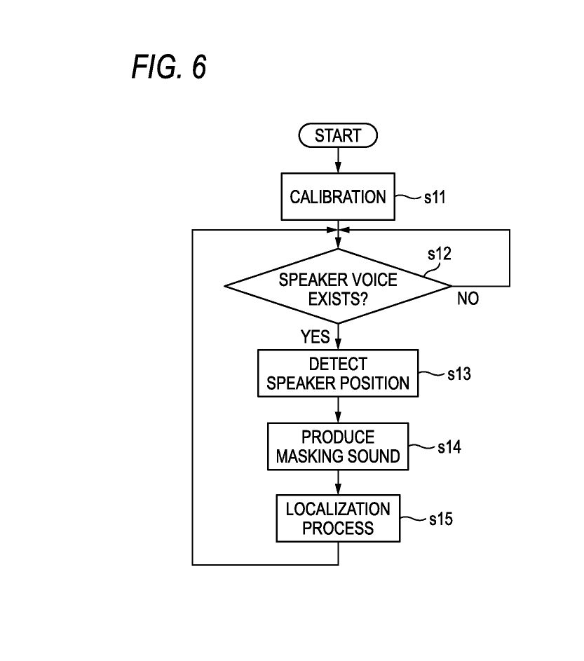

Next, FIG. 6 is a flowchart showing the operation of the sound processing device 3. When initially activated (turn on the power supply), the sound processing device 3 starts the operation. First, the sound processing device 3 performs a measurement (calibration) of the above-described positional relationship of the microphone array 1 and the loudspeaker array 2 (s11). In the case of a casing in which the loudspeaker array 2 and the microphone array 1 are integrated with each other, this process is not required.

Thereafter, the sound processing device 3 waits until the speaker voice is picked up (s12). When a sound of a level at which it is possible to determine that a sound exists is picked up, for example, it is determined that the speaker voice is picked up. In the case where a speaker voice is not picked up and a conversation is not conducted, a masking sound is not required, and therefore a mode where the process of producing a masking sound, and that of localization are waited is set. However, the waiting process may be omitted, and a mode where the process of producing a masking sound, and that of localization may be always performed may be set.

If the speaker voice is picked up, the sound processing device 3 detects the speaker position by means of the picked-up sound signal processing section 71 (s13). The speaker position is performed by detecting the phase differences of sounds picked up by the microphones of the microphone array 1 as described above.

Then, the sound processing device 3 performs the production of the masking sound by means of the masking sound producing section 73 (s14). At this time, preferably, a sound signal (in which the directionality is oriented toward the speaker position) which is synthesized while equalizing the phases of the microphones is input from the picked-up sound signal processing section 71 to the masking sound producing section 73, and a masking sound according to the speaker voice is produced.

Preferably, a masking sound is in a mode where the volume is changed in accordance with the level of the picked up speaker voice. In the case where the level of the picked up speaker voice is low, the speaker voice reaches the third persons H3 at a low level, and the content of a conversation is hardly understood. Therefore, also the level of the masking sound can be lowered. In the case where the level of the picked up speaker voice is high, by contrast, the speaker voice reaches the third persons H3 at a high level, and the content of a conversation is easily understood. Therefore, it is preferable that also the level of the masking sound is set to high.

In the sound processing device 3, finally, the controlling section 72 sets the delay amounts so that the masking sound is localized at the speaker position (s15).

When the speaker position detected by the picked-up sound signal processing section 71 is changed, preferably, the masking sound producing section 73 performs a process of increasing the level of the masking sound. In this case, when it is determined that the speaker position is changed, the picked-up sound signal processing section 71 outputs a trigger signal to the masking sound producing section 73, and, when the trigger signal is input, the masking sound producing section 73 temporarily sets the level of the masking sound to high.

When the speaker position is changed, it is contemplated that the speaker position and the position of the virtual sound source of the masking sound are momentarily different from each other until the calculation of the delay amounts by the controlling section 72 is ended. In this case, there is a possibility that the cocktail party effect is generated and the masking effect is lowered, and therefore a mode where the volume of the masking sound is temporarily increased and the masking effect is prevented from being lowered is set.

As described above, the sound processing device 3 localizes the position of the virtual sound source of the masking sound to the detected speaker position, whereby the third persons H3 are caused to hear the voice of the speaker H1 and the masking sound from the same position, and the cocktail party effect can be adequately suppressed.

In the embodiment, the example where the speaker position is detected by detecting the phase differences of the microphones of the microphone array 1 has been described. The method of detecting the speaker position is not limited to this example. For example, an example in which the speaker has a remote controller having a GPS function, and the position information is transmitted to a sound processing device may be employed. Alternatively, a microphone is disposed in a remote controller, a measurement sound is output from a plurality of loudspeakers of a loudspeaker array, and a sound processing device measures the arrival times, thereby detecting the speaker position.

In the above description, the example has been described where the loudspeaker array in which the plurality of loudspeakers are arranged, and the microphone array 1 in which the plurality of microphones are arranged are used. Alternatively, individual loudspeakers and microphones are placed at respective predetermined positions, and a masking sound is generated.

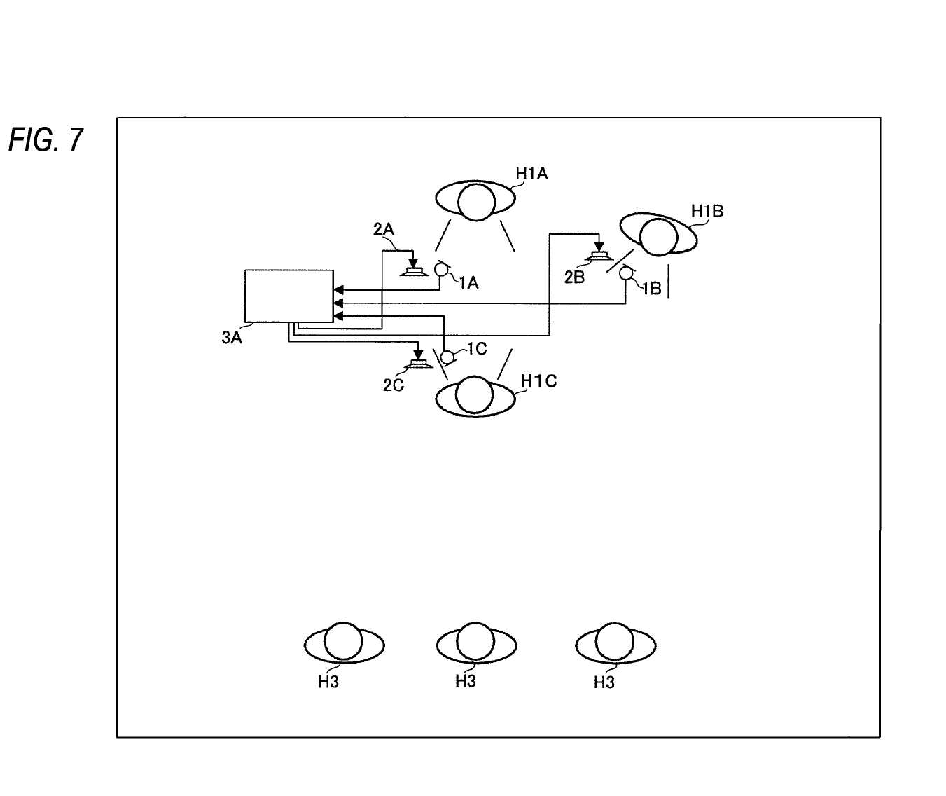

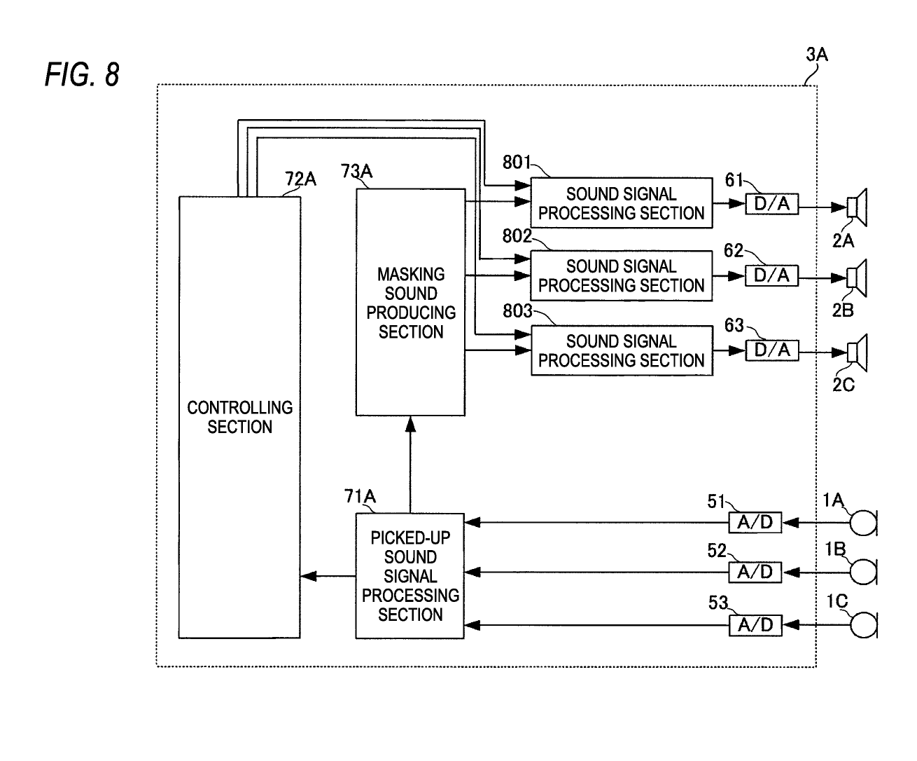

FIG. 7 is a view showing the configuration of a masking system in another embodiment. FIG. 8 is a block diagram showing the configurations of microphones, loudspeakers, and sound processing device of the masking system shown in FIG. 7.

As shown in FIG. 7, in the masking system in the embodiment, microphones 1A, 1B, 1C each configured by an individual device are disposed in an area where speakers H1A, H1B, H1C exist. The microphone 1A is placed in the vicinity of the speaker H1A, the microphone 1B in the vicinity of the speaker H1B, and the microphone 1C in the vicinity of the speaker H1C.

A loudspeaker 2A is placed in the vicinity of the microphone 1A, a loudspeaker 2B in the vicinity of the microphone 1B, and a loudspeaker 2C in the vicinity of the microphone 1C. The loudspeakers 2A, 2B, 2C are disposed so as to emit a sound toward an area where the third persons H3 exist.

In a similar manner as the above-described embodiment, picked-up sound signals of the microphones 1A, 1B, 1C are analog-digital converted by the A/D converters 51 to 53, and then supplied to a picked-up sound signal processing section 71A. The picked-up sound signal processing section 71A detects the microphone which is close to the uttering speaker, from the volume levels of the picked-up sound signals, and outputs the detection information to a controlling section 72A.

The picked-up sound signals are given to a masking sound producing section 73A. In the manner described in the above embodiment, by using the picked-up sound signals, the masking sound producing section 73A produces a masking sound, and supplies the masking sound to sound signal processing sections 801, 802, 803.

In the controlling section 72A, correspondence relationships between a microphone and loudspeaker which are close to each other are stored. The controlling section 72A selects the loudspeaker corresponding to the microphone which is detected by the picked-up sound signal processing section 71A, and controls the sound signal processing sections 801, 802, 803 so that only the loudspeaker emits a sound. Specifically, when the speaker H1A utters a voice sound and the microphone 1A is detected, the controlling section 72A causes only the sound signal processing section 801 to output the masking sound so that the masking sound is emitted only from the loudspeaker 2A which is close to the detected microphone. When the speaker H1B utters a voice sound and the microphone 1B is detected, the controlling section 72B causes only the sound signal processing section 802 to output the masking sound so that the masking sound is emitted only from the loudspeaker 2B which is close to the detected microphone. When the speaker H1C utters a voice sound and the microphone 1C is detected, the controlling section 72B causes only the sound signal processing section 803 to output the masking sound so that the masking sound is emitted only from the loudspeaker 2C which is close to the detected microphone.

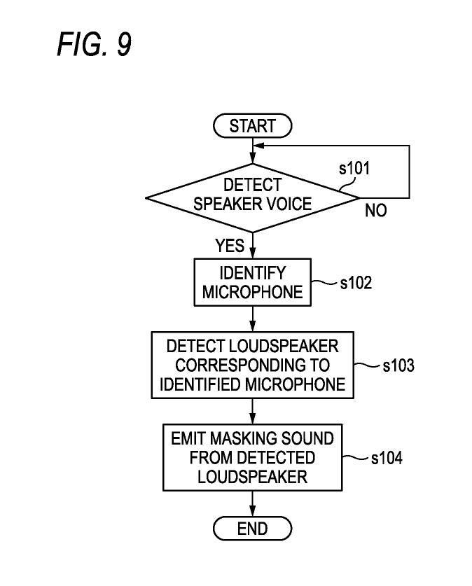

FIG. 9 is a flowchart showing the operation of the sound processing device in the masking system shown in FIG. 7.

The sound processing device 3A waits until the speaker voice is picked up (s101: No). The method of detecting a picked-up sound is similar to the above-described flowchart shown in FIG. 6. If the speaker voice is picked up (s101: Yes), the sound processing device 3A analyzes the picked-up sound signals of the microphones 1A, 1B, 1C to identify the microphone which picks up the speaker voice (s102).

Next, the sound processing device 3A detects the loudspeaker corresponding to the identified microphone (s103). Then, the sound processing device 3A causes only the detected loudspeaker to emit the masking sound (s104).

According to the above-described configuration and process, the masking sound is emitted from a close vicinity of the position of the uttering speaker, and the cocktail party effect can be adequately suppressed.

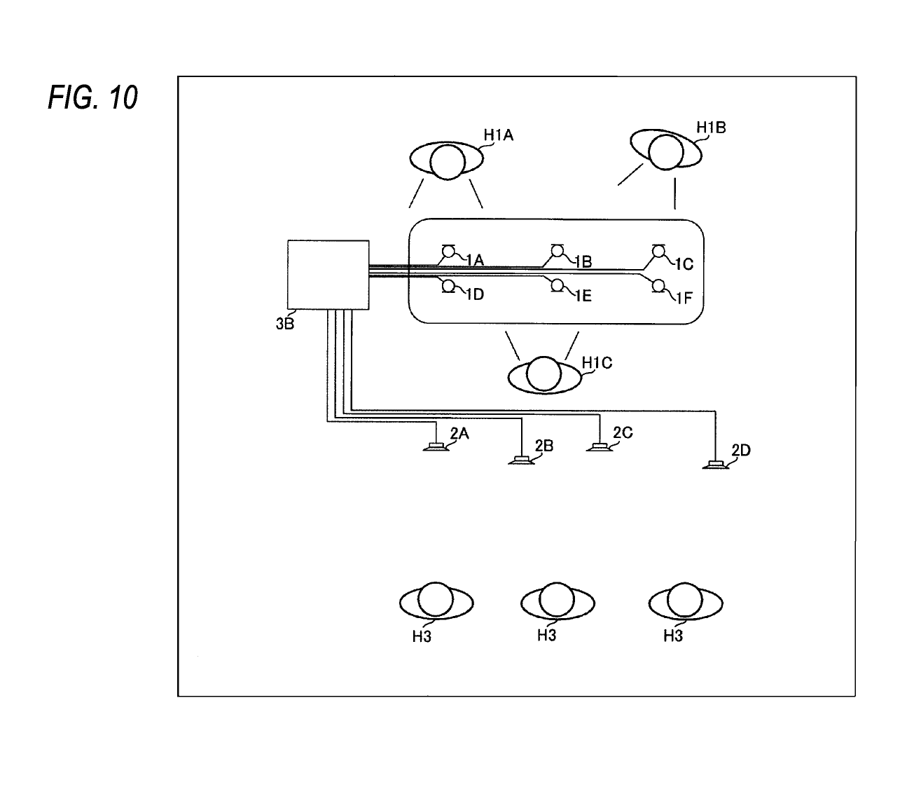

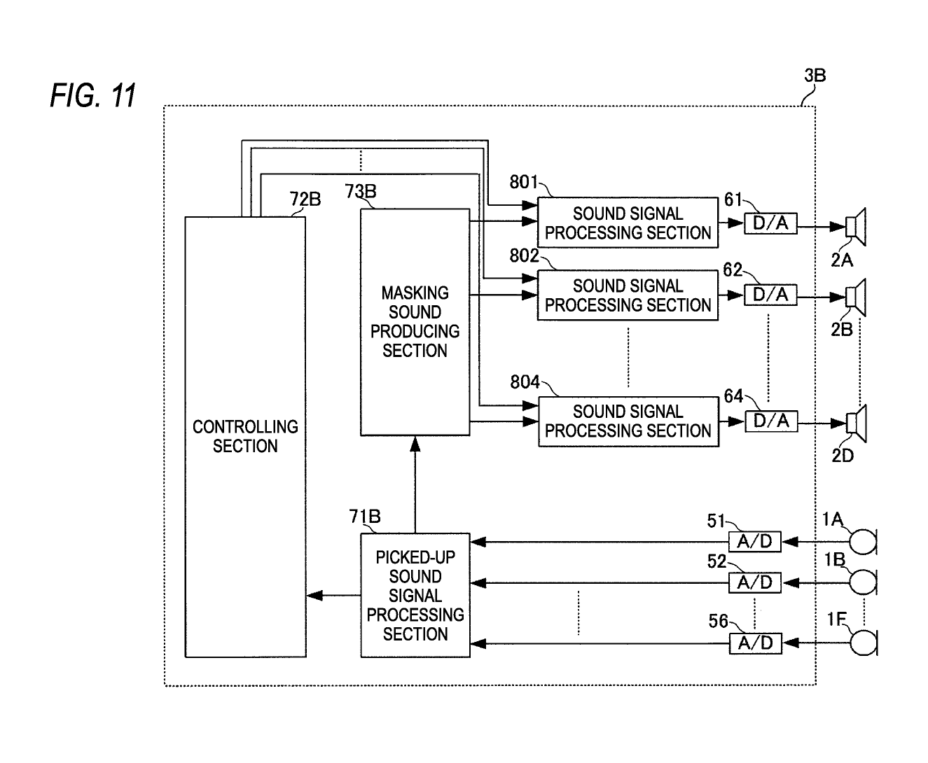

A masking system which is configured in the following manner may be employed. FIG. 10 is a view showing the configuration of a masking system in an embodiment which is different from the above-described masking system. FIG. 11 is a block diagram showing the configurations of microphones, loudspeakers, and sound processing device of the masking system shown in FIG. 10.

In the masking system shown in FIG. 10, a table on which microphones 1A, 1B, 1C, 1D, 1E, 1F are mounted is placed in an area where the speakers H1A, H1B, H1C exist.

The microphones 1A, 1B, 1C and the microphones 1D, 1E, 1F are placed so that the respective sound pick-up directions are opposite to each other. In the example of FIG. 10, specifically, the microphones 1A, 1B, 1C pick up a sound on the side where the speakers H1A, H1B exist, and the microphones 1D, 1E, 1F pick up a sound on the side where the speaker H1C exists.

Loudspeakers 2A, 2B, 2C, 2D are placed between the area where the speakers H1A, H1B, H1C exist, and that where the third persons H3 exists, and the placement intervals and positional relationships may not be fixed.

In a similar manner as the above-described embodiment, picked-up sound signals of the microphones 1A, 1B, 1C, 1D, 1E, 1F are analog-digital converted by the A/D converters 51 to 56, and then supplied to a picked-up sound signal processing section 71B. The picked-up sound signal processing section 71B detects the microphone which is close to the uttering speaker, from the volume levels of the picked-up sound signals, and outputs the detection information to a controlling section 72B.

The picked-up sound signals are given also to a masking sound producing section 73B. In the manner described in the above embodiment, by using the picked-up sound signals, the masking sound producing section 73B produces a masking sound, and supplies the masking sound to sound signal processing sections 801 to 804.

In the controlling section 72B, positional relationships between the microphones 1A, 1B, 1C, 1D, 1E, 1F and the loudspeakers 2A, 2B, 2C, 2D are stored. The positional relationships can be realized by the process which is called calibration in the above-described embodiment.

The controlling section 72B selects the loudspeaker which is closest to the microphone that is detected by the picked-up sound signal processing section 71B, and controls the sound signal processing sections 801 to 804 so that only the loudspeaker emits a sound.

According to the above-described configuration and process, the third persons H3 can hear the masking sound in the direction of the speaker, and the cocktail party effect can be adequately suppressed.

The controlling section 72B may determine the levels of the sound emissions from the loudspeakers 2A, 2B, 2C, 2D by using the distances between the loudspeakers 2A, 2B, 2C, 2D and the microphones 1A, 1B, 1C, 1D, 1E, 1F, and perform a control of adjusting the gains of the sound signal processing sections 801 to 804.

In this case, the picked-up sound signal processing section 71B detects the levels of the picked-up sound signals of the microphones 1A, 1B, 1C, 1D, 1E, 1F, and outputs the levels to the controlling section 72B.

The controlling section 72B previously measures the distances between the microphones 1A, 1B, 1C, 1D, 1E, 1F and the loudspeakers 2A, 2B, 2C, 2D. This can be realized by the above-described calibration process.

Next, the controlling section 72B calculates a coefficient which is the reciprocal of the distance, for each of combinations of the microphones 1A, 1B, 1C, 1D, 1E, 1F and the loudspeakers 2A, 2B, 2C, 2D, and stores the calculated coefficients for the respective combinations of the microphones and the loudspeakers. For example, a coefficient A11 is stored for the combination of the loudspeaker 2A and the microphone 1A, and a coefficient A45 is stored for the combination of the loudspeaker 2D and the microphone 1E. As a result, the following 5×4 coefficient matrix A is set. Each coefficient may be calculated from, for example, the reciprocal of the square of the distance, and set so that the value becomes smaller as the distance is larger,

$$( \begin{matrix}A 11 & A 12 & A 13 & A 14 & A 15 \\ A 21 & A 22 & A 23 & A 24 & A 25 \\ A 31 & A 32 & A 33 & A 34 & A 35 \\ A 41 & A 42 & A 43 & A 44 & A 45\end{matrix} ) \qquad [ Exp . 1 ]$$

Then, the controlling section 72B acquires the picked-up sound signal levels of the microphones 1A, 1B, 1C, 1D, 1E, 1F as a picked-up sound signal level sequence of Ss=(Ss1, Ss2, Ss3, Ss4, Ss5)^{T} where Ss1 is the picked-up sound signal level of the microphone 1A, Ss2 is the picked-up sound signal level of the microphone 1B, Ss3 is the picked-up sound signal level of the microphone 1C, Ss4 is the picked-up sound signal level of the microphone 1D, and Ss5 is the picked-up sound signal level of the microphone 1E.

The controlling section 72B multiplies the picked-up sound signal level sequence Ss with the coefficient matrix A as shown in the following expression to calculate a gain sequence G=(Ga, Gb, Gc, Gd). In the expression, Ga is the gain for the loudspeaker 2A, Gb is the gain for the loudspeaker 2B, Gc is the gain for the loudspeaker 2C, and Gd is the gain for the loudspeaker 2D.

$$( \begin{matrix}Ga \\ Gb \\ Gc \\ Gd\end{matrix} ) = ( \begin{matrix}A 11 & A 12 & A 13 & A 14 & A 15 \\ A 21 & A 22 & A 23 & A 24 & A 25 \\ A 31 & A 32 & A 33 & A 34 & A 35 \\ A 41 & A 42 & A 43 & A 44 & A 45\end{matrix} ) ( \begin{matrix}Ss 1 \\ Ss 2 \\ Ss 3 \\ Ss 4 \\ Ss 5\end{matrix} ) \qquad [ Exp . 2 ]$$

When such a process is performed, the third persons H3 hear the masking sound emitted from the loudspeakers 2A, 2B, 2C, 2D as a sound arriving in the direction of the speaker. Therefore, the cocktail party effect can be adequately suppressed.

The above-described sound processing devices can be realized not only by using a device dedicated to the masking system shown in the embodiment, but also by using hardware and software of an information processing device such as a usual personal computer.

Hereinafter, a summary of the invention will be described in detail.

The audio output device of the invention includes: a speaker position detecting unit which detects a position of a speaker; a masking sound producing section which produces a masking sound; a plurality of loudspeakers which output the masking sound; and a localization controlling section which controls a localization position of a virtual sound source of the masking sound so that the virtual sound source is placed at or in the vicinity of the position of the speaker which is detected by a speaker position detecting unit, and which supplies a sound signal relating to the masking sound to at least one of the plurality of loudspeakers.

Specifically, the localization controlling section sets the localization position of the masking sound so that the masking sound arrives in the same direction as the speaker, as seen from the third person. More preferably, the localization controlling section sets the speaker position detected by the speaker position detecting section, and the localization position of the masking sound to the same position. According to the configuration, the masking sound and the speaker voice are prevented from being heard from different positions, and the cocktail party effect can be adequately suppressed.

Any method may be employed as the method of detecting the speaker position. For example, it may be contemplated that the audio output device includes a microphone array in which a plurality of microphones that pick up a sound are arranged, and a phase difference of sounds picked up by the microphones is detected, so that the speaker position is accurately detected.

In this case, preferably, the localization controlling section controls the localization position of the masking sound while considering the positional relationship between the loudspeaker array and the microphone array. The positional relationship may be manually input by the user, or may be obtained by, for example, picking up sounds output from the loudspeakers by means of the microphones, to measure the arrival times.

In a casing in which the loudspeaker array and the microphone array are integrated with each other, the positional relationship between the loudspeaker array and the microphone array is fixed. When the positional relationship is previously stored, therefore, it is not necessary to input or measure the positional relationship each time.

Preferably, the masking sound producing section sets the level of the masking sound to a high level in a case where the speaker position detected by the speaker position detecting section is changed. When the speaker position is changed, it is contemplated that the speaker position and the localization position of the masking sound are momentarily different from each other. In this case, there is a possibility that the cocktail party effect is generated and the masking effect is lowered, and therefore a mode where the volume of the masking sound is temporarily increased and the masking effect is prevented from being lowered is set.

The speaker position detecting section may set a position of a microphone in which the volume level of a picked-up sound is highest, as the speaker position, and the localization controlling section may supply a sound signal relating to the masking sound, to a loudspeaker that is closest to the microphone in which the volume level of the picked-up sound is highest.

Furthermore, the audio output device of the invention includes: a plurality of microphones which pick up a sound; a masking sound producing section which produces a masking sound; a plurality of loudspeakers to which a sound signal relating to the masking sound is supplied, and which emit the masking sound; and a localization controlling section which controls a gain of the sound signal relating to the masking sound to be supplied to the plurality of loudspeakers. The localization controlling section multiplies levels of picked-up sound signals of the plurality of microphones with a gain setting coefficient having a value which becomes smaller as distances between the plurality of microphones and the plurality of loudspeakers are larger, thereby adjusting the gain of the sound signal relating to the masking sound to be supplied to the plurality of loudspeakers.

According to the configuration, even when the speaker position is not detected, the masking sound can be emitted so that the masking sound is heard in the direction of the speaker position, by using only the positional relationships between the plurality of microphones and the plurality of loudspeakers, and the levels of the picked-up sound signals of the microphones.

The above-described embodiments merely illustrate typical forms of the invention, and the invention is not limited to the embodiments. Namely, the invention may be performed with various modifications without departing from the spirit of the invention.

The application is based on Japanese Patent Application (No. 2010-216270) filed on Sep. 28, 2010 and Japanese Patent Application (No. 2011-063438) filed on Mar. 23, 2011, and the contents of which are incorporated herein by reference.

### INDUSTRIAL APPLICABILITY

According to the audio output device and audio output method of the invention, the masking sound and the speaker voice are heard in the same direction, and therefore the cocktail party effect can be adequately suppressed.

### DESCRIPTION OF REFERENCE NUMERALS AND SIGNS

H1 speaker
H2 listener
H3 third person
1 microphone array
1A, 1B, 1C, 1D, 1E, 1F microphone
2 loudspeaker array
2A, 2B, 2C, 2D loudspeaker
3, 3A, 3B sound processing device

1. An audio output device comprising:
a speaker position detecting section adapted to detect a position of a speaker;
a masking sound producing section adapted to produce a masking sound;
a plurality of loudspeakers adapted to output the masking sound; and
a localization controlling section adapted to control a localization position of the masking sound based on the speaker position detected by the speaker position detecting section, and supply a sound signal relating to the masking sound to at least one of the plurality of loudspeakers.

2. The audio output device according to claim 1, wherein the localization controlling section sets the localization position of the masking sound to the speaker position detected by the speaker position detecting section.

3. The audio output device according to claim 1, further comprising:
a microphone array in which a plurality of microphones that pick up a sound are arranged,
wherein the speaker position detecting section detects the speaker position based on a phase difference of sounds picked up by the plurality of microphones.

4. The audio output device according to claim 1, wherein the masking sound producing section sets a level of the masking sound to a high level in a case where the speaker position detected by the speaker position detecting section is changed.

5. The audio output device according to claim 1, wherein the speaker position detecting section sets a position of a microphone in which a volume level of a picked-up sound is highest, as the speaker position; and
wherein the localization controlling section supplies the sound signal relating to the masking sound, to a loudspeaker that is closest to the microphone in which the volume level of the picked-up sound is highest.

6. An audio output device comprising:
a plurality of microphones adapted to pick up a sound;
a masking sound producing section adapted to produce a masking sound;
a plurality of loudspeakers to which a sound signal relating to the masking sound is supplied, and adapted to emit the masking sound; and
a localization controlling section adapted to control a gain of the sound signal relating to the masking sound to be supplied to the plurality of loudspeakers,
wherein the localization controlling section multiplies levels of picked-up sound signals of the plurality of microphones with a gain setting coefficient having a value which becomes smaller as distances between the plurality of microphones and the plurality of loudspeakers are larger, to adjust the gain of the sound signal relating to the masking sound to be supplied to the plurality of loudspeakers.

7. An audio output method comprising the steps of:
detecting a position of a speaker;
producing a masking sound;
outputting the masking sound from at least one of a plurality of loudspeakers; and
controlling a localization position of a virtual sound source of the masking sound so that a position of the virtual sound source is placed at or in a vicinity of the speaker position detected in the speaker position detecting step, and supplying a sound signal relating to the masking sound to at least one of the plurality of loudspeakers.

8. The audio output method according to claim 7, wherein in the localization controlling step, the localization position of the masking sound is se to the speaker position detected in the speaker position detecting step.

9. The audio output method according to claim 7, further comprising:
a step of picking up a sound by a microphone array in which a plurality of microphones are arranged,
wherein in the speaker position detecting step, the speaker position is detected based on a phase difference of sounds picked up by the plurality of microphones.

10. The audio output method according to claim 7, wherein, in a case where the speaker position detected in the speaker position detecting step is changed, in the masking sound producing step, a level of the masking sound is set to a high level.

11. The audio output method according to claim 7, wherein in the speaker position detecting step, a position of a microphone in which a volume level of a picked-up sound is highest is set as the speaker position; and
wherein in the localization controlling step, the sound signal relating to the masking sound is supplied to a loudspeaker that is closest to the microphone in which the volume level of the picked-up sound is highest.

12. An audio output method comprising the steps of:
picking up a sound by a plurality of microphones;
producing a masking sound;
supplying a sound signal relating to the masking sound to a plurality of loudspeakers, and emitting the masking sound by the plurality of loudspeakers; and
controlling a gain of the sound signal relating to the masking sound which is to be supplied to the plurality of loudspeakers,
wherein in the localization controlling step, levels of picked-up sound signals of the plurality of microphones are multiplied with a gain setting coefficient having a value which becomes smaller as a distance between the plurality of microphones and the plurality of loudspeakers is larger, to adjust the gain of the sound signal relating to the masking sound to be supplied to the plurality of loudspeakers.
